(19) United States
(12) Patent Application Publication
(10) Pub. No.: US 2008/0222168 A1
(43) Pub. Date: Sep. 11, 2008

(54) Method and System for Hierarchical Document Management in a Document Review System

(75) Inventor: David A. Morales, El Paso, TX (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: ALTEP, INC., El Paso, TX (US)

(21) Appl. No.: 12/038,791

(22) Filed: Feb. 27, 2008

Related U.S. Application Data
(60) Provisional application No. 60/893,602, filed on Mar. 7, 2007.
(60) Provisional application No. 60/893,612, filed on Mar. 7, 2007.
(60) Provisional application No. 60/911,822, filed on Apr. 13, 2007.

(51) Int. Cl. G06F 17/30

(52) U.S. Cl. 707/100

(57) ABSTRACT

A method and machine-readable medium for reviewing documents are described. A computer-implemented method comprising: receiving a plurality of documents; for each document in the plurality of documents: determining if the document is attached to a parent document; if the document is not attached to a parent document, creating a root node in a hierarchy corresponding to the document; and if the document is attached to a parent document, creating a child node in the hierarchy corresponding to the attached document, the child node being inserted as a child of the node corresponding to the parent document; and selecting a first document; and performing an action on the first document and any documents having a specified relationship to the first document based on the hierarchy. In other embodiments, the process includes a machine-readable medium that provides instructions for a processor, which when executed by the processor cause the processor to perform a method of the present invention.

### CROSS-REFERENCE TO RELATED APPLICATIONS

This application claims benefit and priority under 35 U.S.C. §119(e) of the following co-pending provisional applications having at least one common inventor with this application: Ser. No. 60/911,822, filed Apr. 13, 2007, entitled “Method and System for Hierarchical Document Management in a Document Review System”; Ser. No. 60/893,612, filed Mar. 7, 2007, entitled “Method and System for Searching and Generating To Do List”; Ser. No. 60/893,602, filed Mar. 7, 2007, entitled “Method and System for Document Searching”. The entire disclosures of the above applications are incorporated herein by reference.

The entire disclosure of commonly-assigned co-pending application Ser. No. not yet assigned, attorney docket no. 101915-200101/US, entitled “Method and System for Rules Based Tag Management in a Document Review System,” by inventor Willem van de Berge, filed the same day as this application, is incorporated herein by reference.

The entire disclosure of commonly-assigned co-pending application Ser. No. not yet assigned, attorney docket no. 101915-200201/US, entitled “Method and System for Document Searching,” by inventor David A. Morales, filed the same day as this application, is incorporated herein by reference.

The entire disclosure of commonly-assigned co-pending application Ser. No. not yet assigned, attorney docket no. 101915-200301/US, entitled “Method and System for Searching and Generating To Do List,” by inventor David A. Morales, filed the same day as this application, is incorporated herein by reference.

The entire disclosure of commonly-assigned co-pending application Ser. No. not yet assigned, attorney docket no. 101915-200401/US, entitled “Method and System for Universal File Types in a Document Review System,” by inventor Willem van den Berge, filed the same day as this application, is incorporated herein by reference.

### TECHNICAL FIELD

This invention relates generally to the field of document review systems. More particularly, the invention relates to a method and machine-readable medium for hierarchical document management in a document review system.

### BACKGROUND

Document review systems are employed to search for specific words or phrases within a set of documents and identify documents that meet specified criteria with a common identifier.

Document review systems are used for managing the document review in the discovery phase of litigation to determine, for example, which documents are relevant and which are irrelevant to the litigation. A document that is relevant may be assigned a tag classifying it as relevant. A document that is irrelevant may be assigned a tag classifying it as irrelevant.

Documents can have attachments and the attached documents can have attachments and so on. In some cases, document reviewers want to tag a selected document and other documents which have an attachment relationship with the selected document. In other cases, document reviewers want to see the attachment relationship between documents.

In prior art methods, users can determine the attachment relationship of each document by looking up document identifiers of each attached document and tagging the identified documents. What is needed is an ability to more efficiently tag documents having an attachment relationship with a selected document.

### BRIEF SUMMARY

A method and machine-readable medium for reviewing documents are described. A computer-implemented method comprising: receiving a plurality of documents; for each document in the plurality of documents: determining if the document is attached to a parent document; if the document is not attached to a parent document, creating a root node in a hierarchy corresponding to the document; and if the document is attached to a parent document, creating a child node in the hierarchy corresponding to the attached document, the child node being inserted as a child of the node corresponding to the parent document; and selecting a first document; and performing an action on the first document and any documents having a specified relationship to the first document based on the hierarchy. In other embodiments, the process includes a machine-readable medium that provides instructions for a processor, which when executed by the processor cause the processor to perform a method of the present invention.

### BRIEF DESCRIPTION OF THE DRAWINGS

These and other features, aspects, and advantages of the present invention will become better understood with regard to the following description, appended claims, and accompanying drawings where:

FIG. 1 illustrates a flow diagram of a method of tagging documents in a hierarchy according to one embodiment.

FIG. 2 shows a representation of a screen image in one embodiment of a document review process.

FIG. 3 shows a representation of parent and child nodes in relationships describing one embodiment of a document hierarchy.

FIG. 4 shows a representation of a screen image in one embodiment of the display of the document hierarchy and parent/child node relationships.

FIG. 5 shows a diagrammatic representation of a machine in the exemplary form of a computer system.

### DETAILED DESCRIPTION

At least some embodiments of the disclosure relate to a method and machine-readable medium for hierarchical document management in a document review system.

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but are not necessarily, references to the same embodiment; and such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

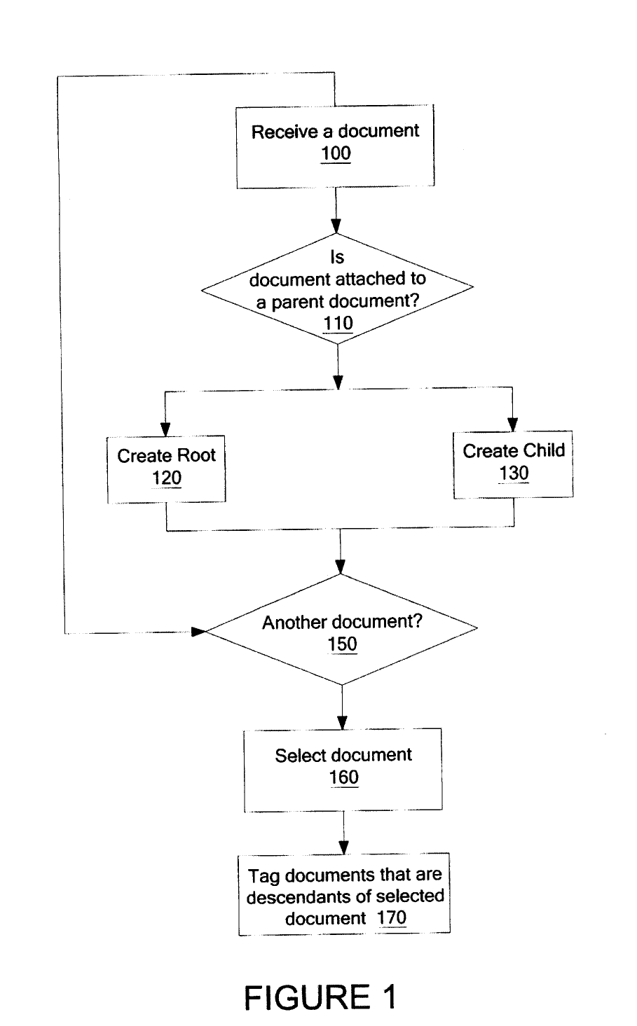

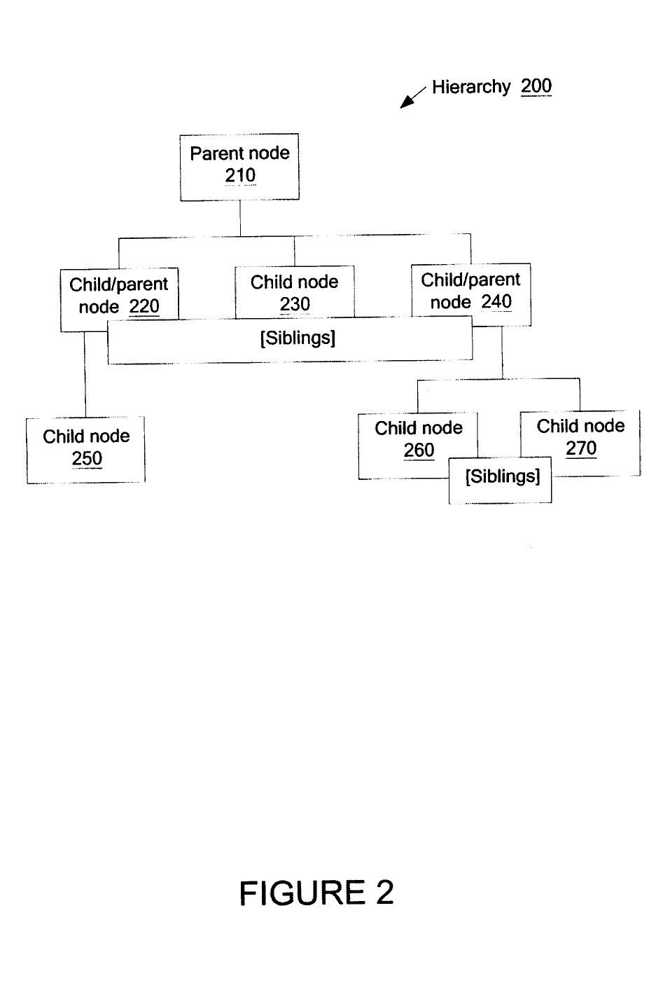

FIG. 1 is one embodiment of a method of hierarchical document management in a document review system. FIG. 1 is described in conjunction with FIGS. 2, 3, and 4 representing screen images and diagrams in one embodiment of the invention.

In process 100, a document is received. In one embodiment, the document is received into a database of documents to be accessed for a document review project. Alternatively, other processes for receiving documents may be used.

In process 110, it is determined whether the received document is attached to a parent document. For example, an email may have several documents attached to it. The email may have word processing, spreadsheet, and presentation documents attached, for example. In that case, the email is a parent document and each of the documents attached directly to the email is a child document. In other embodiments, a compressed archive (.zip) file may contain many documents, each of which would be treated as an attachment of the parent archive file. If a document is not attached to a parent document, process 120 is performed. If the document is attached to a parent document, process 130 is performed.

In process 120, a root node corresponding to the received document is created. The root node is part of a hierarchy that may or may not include other nodes depending on whether there are any attachments to the root document. The document associated with the root node is a root document.

In process 130, a child node corresponding to the received document is created. The child node is appended to the node corresponding to the document to which the document was directly attached.

In one embodiment, each node contains a reference to the corresponding document and references to other nodes that indicate the attachment relationship between documents corresponding to the respective nodes. Each hierarchy includes all the attachment relationships of the received documents having an attachment relationship with a root document.

FIG. 2 shows one embodiment of a hierarchy 200. A parent node 210 is the root node for the hierarchy 200. A child/parent node 220 is a child node of the parent node 210 and the parent node of a child node 250. A child node 230 is a child node of the parent node 210. A child/parent node 240 is a child node of the parent node 210 and the parent node of a child node 260 and the child node 270. Child/parent node 220, child node 230 and child/parent node 240 are related to each other as sibling nodes. Child node 260 and child node 270 are related to each other as sibling nodes. The child/parent node 220, the child node 230, the child/parent node 240, the child node 250, the child node 260 and the child node 270 are descendants of the parent node 210. Further generations of child nodes can be created depending on the attachment relationship between received documents. Furthermore, multiple hierarchies can be created depending on the number of documents received that are not attached to any other document.

In process 150, it is determined if another document is to be received. If another document is to be received, process 100 is performed. Otherwise, process 160 is performed.

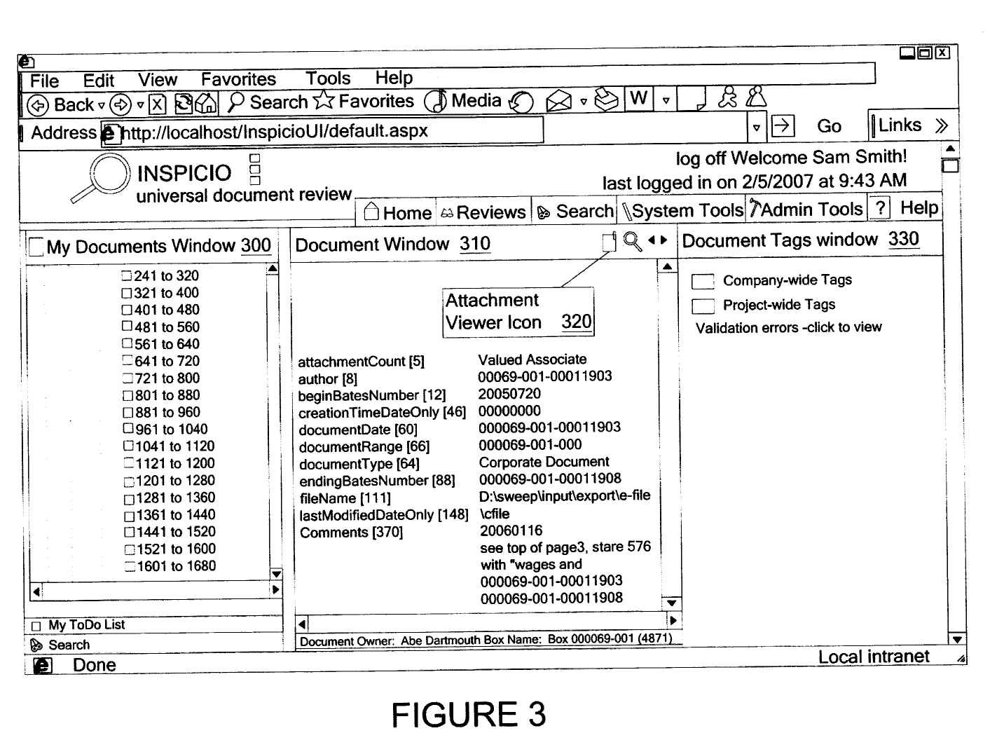

In process 160, a document is selected. FIG. 3 illustrates a screen shot of one embodiment of a document review system. The My Documents window 300 shows a document folders and documents which may be selected. A document window 310 shows a display with details about a selected document. In another embodiment, the document window 310 displays the document. A document tags window 330 shows a folder structure with company-wide tags and project-wide tags. Tags may be characteristics of a document that may be used to classify documents. For example, a document may be tagged “relevant” or “irrelevant” depending whether it is determined to be relevant to a litigation case. Some tags may be available for associating with all document review work for a particular company. Other tags may be available for document review work for a particular project. An attachment viewer icon 320 is clicked to display attachment information about the selected document.

In process 170, the selected document and its descendants are tagged. In some cases, a document and all its descendants should be associated with the same tag. In one example, an email is a parent document and the email has several attachments and some of those attachments have attachments and so on. In other embodiments the document and all its descendants may be tagged differently depending on the review of each document.

The directly and indirectly attached documents are descendants of the email. The email and the descendants can be tagged by applying appropriate tags to the parent document, then navigating to each of the descendant documents and applying tags to each as required. Other selected relationships may be used. For example, the parent of the selected document and its descendants may be tagged. In another embodiment, the siblings of the selected document may be tagged. In yet another embodiment, the child nodes of the selected document may be tagged. Other relationships within the hierarchy may be used to select a set of documents to be tagged within the hierarchy.

In another embodiment, the hierarchy of attachment relationships for the selected document, its parent and its descendants are displayed.

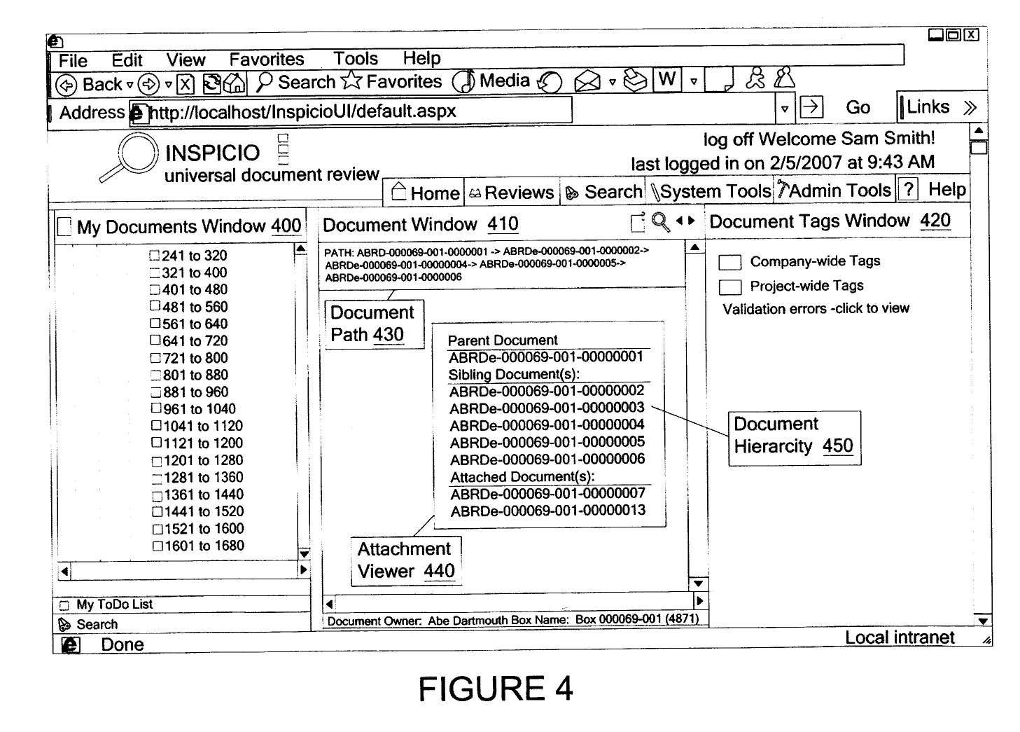

FIG. 4 illustrates a screen shot of one embodiment of a document review system showing attachment information about a document after a user clicks the attachment viewer icon. The My Documents window 400 shows a document folders and documents which may be selected. A document window 410 shows a display with details about a selected document. In another embodiment, the document window 410 displays the document. A document tags window 420 shows a folder structure with company-wide tags and project-wide tags.

A document path 430 shows the path from the selected document to the root document in the hierarchy. A document identifier for each document in the path is shown.

An attachment viewer window 440 displays the document identifiers for the parent document of the selected document, the sibling documents and the attached documents. The document hierarchy 450 is at least a portion of the hierarchy. In some cases, the attachments may have attachments and the complete hierarchy is not displayed. In other cases, the entire hierarchy of documents having an attachment relationship is displayed.

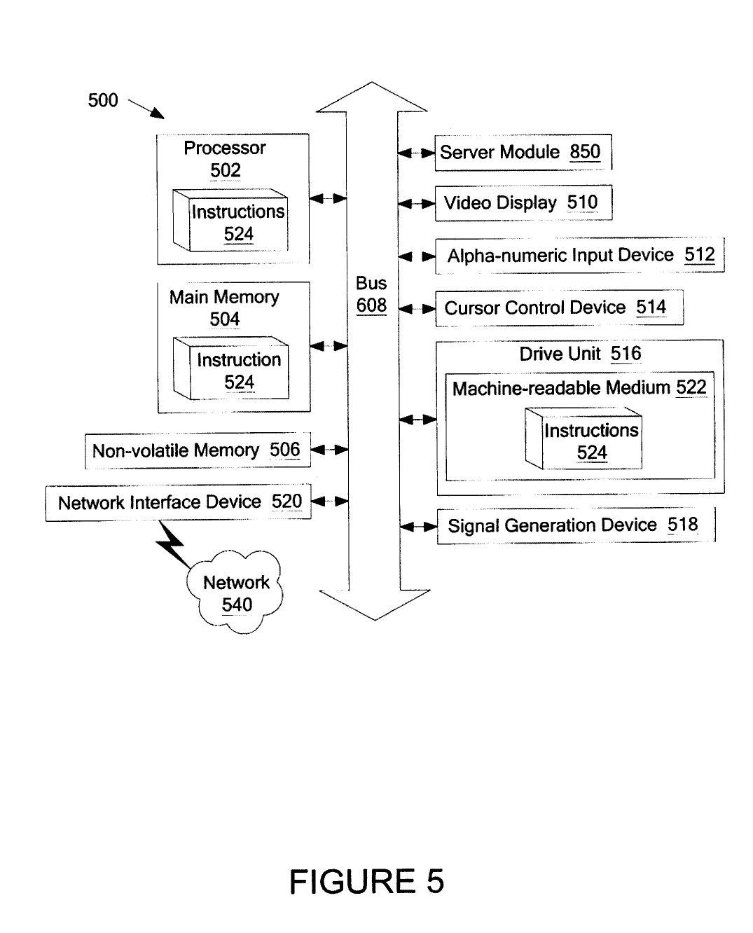

FIG. 5 shows a diagrammatic representation of a machine in the exemplary form of a computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In one embodiment, the machine communicates with the server to facilitate operations of the server and/or to access the operations of the server.

The computer system 600 includes a processor 602 (e.g., a central processing unit (CPU) a graphics processing unit (GPU) or both), a main memory 604 and a nonvolatile memory 606, which communicate with each other via a bus 608. In some embodiments, the computer system 600 may be a laptop computer, personal digital assistant (PDA) or mobile phone, for example. The computer system 600 may further include a video display unit 610 (e.g., a liquid crystal display (LCD) or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620. The disk drive unit 616 includes a machine-readable medium 622 on which is stored one or more sets of instructions (e.g., software 624) embodying any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media. The software 624 may further be transmitted or received over a network 640 via the network interface device 620.

While the machine-readable medium 622 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable-medium” shall accordingly be taken to include, but not be limited to, solid-state memories, optical and magnetic media, and carrier wave signals.

In general, the routines or processes executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs)., etc.), among others, and transmission type media such as digital and analog communication links.

Although embodiments have been described with reference to specific exemplary embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer-implemented method comprising:
receiving a plurality of documents;
for each document in the plurality of documents:
determining if the document is attached to a parent document;
if the document is not attached to a parent document, creating a root node in a hierarchy corresponding to the document; and
if the document is attached to a parent document, creating a child node in the hierarchy corresponding to the attached document, the child node being inserted as a child of the node corresponding to the parent document; and
selecting a first document; and
performing an action on the first document and at least one of the documents having a specified relationship to the first document based on the hierarchy.

2. The computer-implemented method of claim 1 wherein the action is displaying at least a portion of the hierarchy.

3. The computer-implemented method of claim 1 wherein the action is tagging the documents.

4. The computer-implemented method of claim 1 wherein the specified relationship to the first document is a child relationship.

5. The computer-implemented method of claim 1 wherein the specified relationship to the first document is a sibling relationship.

6. The computer-implemented method of claim 1 wherein the specified relationship to the first document is a descendant relationship.

7. A machine-readable medium that provides instructions for a processor, which when executed by the processor cause the processor to perform a method comprising:
receiving a plurality of documents;
for each document in the plurality of documents:
determining if the document is attached to another document;
if the document is not attached to another document, creating a root node in a hierarchy corresponding to the document; and
if the document is attached to a parent document, creating a child node in the hierarchy corresponding to the attached document, the child node being inserted as a child of the node corresponding to the parent document; and
selecting a first document; and
performing an action on the first document and at least one of the documents having a specified relationship to the first document based on the hierarchy.

8. The machine-readable medium of claim 7 wherein the action is displaying at least a portion of the hierarchy.

9. The machine-readable medium of claim 7 wherein the action is tagging the documents.

10. The machine-readable medium of claim 7 wherein the specified relationship to the first document is a child relationship.

11. The machine-readable medium of claim 7 wherein the specified relationship to the first document is a sibling relationship.

12. The machine-readable medium of claim 7 wherein the specified relationship to the first document is a descendant relationship.
